(19) United States
(12) Patent Application Publication
(10) Pub. No.: US 2014/0319261 A1
(43) Pub. Date: Oct. 30, 2014

(54) STUMP GRINDING CUTTER BIT WITH CUTTING INSERT HAVING EDGE PREPARATION

(71) Applicant: KENNAMETAL INC., Latrobe, PA (US)

(72) Inventors: Nicholas J. Paros, Johnstown, PA (US); Stephen M. George, Greensboro, NC (US); Glenn W. Sheffler, Blairsville, PA (US); Don C. Rowlett, Bedford, PA (US)

(73) Assignee: Kennametal Inc., Latrobe, PA (US)

(21) Appl. No.: 13/871,029

(22) Filed: Apr. 26, 2013

(51) Int. Cl. A01G 23/06

(52) U.S. Cl. CPC A01G 23/067
USPC 241/300; 241/291

(57) ABSTRACT

A stump grinding cutter bit includes a non-rotatable shank portion, a head portion integrally formed with the non-rotatable shank portion and including a tip region distal from the non-rotatable shank portion, and a cutting insert mounted at the tip region of the head portion. The cutting insert includes: a body having a top surface, a leading face, an opposing trailing face, a first side and a second side; a T-land surface extending between the leading face and the top surface and extending between the leading face and the first side and second side; and a cutting edge formed at the intersection of the T-land surface and the top surface and at the intersection of the T-land surface and the first side and the second side.

### BACKGROUND OF THE INVENTION

The invention pertains generally to an excavating tool such as, for example, a cutter bit useful for cutting through various earth strata and other materials. More specifically, the invention pertains to a stump grinding cutter bit with a cutting insert having edge preparation.

Various types of cutting assemblies having cutter bits are used for mining, construction, stump grinding and related operations wherein, typically, the cutter bits include a shank for insertion into a tool holder and a forward working portion on the shank for engagement with earth strata, e.g., coal, or mineral formation or other natural materials or the like. An individual insert formed of a hard, wear resistant material is provided on the forward working portion to cut into the earth strata or other material and to enhance the life of the cutter bit as it removes the material.

These types of cutting tools usually include a plurality of cutter bits mounted on a rotatable disc, rake, chain, barrel or drum, wherein each of the cutter bits include a substantially-flat cutting insert made of a hard material. These substantially-flat cutting inserts are affixed to the forward working end of the cutter bits. However, it has been determined that due to the shape and configuration of the substantially-flat cutter inserts, the cutter inserts do not wear uniformly. This non-uniform wear decreases the overall useful life of the cutting inserts. More particularly, the cutting edge of the substantially-flat cutter inserts have a tendency to chip or break during use due to the shape of the cutting edge.

Accordingly, it would be desirable to provide improved cutting tools that overcome limitations and disadvantages of known such tools. In addition, it would be desirable to provide improved cutter bits that overcome limitations and disadvantages of known cutter bits and that provide for improved wear and efficiency during operation. Furthermore, it would be desirable to provide improved cutting inserts for cutter bits that overcome limitations and disadvantages of known cutting inserts and that provide for improved wear and efficiency during operation.

### SUMMARY OF THE INVENTION

In accordance with an aspect of the invention, a stump grinding cutter bit includes a non-rotatable shank portion, a head portion integrally formed with the non-rotatable shank portion and including a tip region distal from the non-rotatable shank portion, and a cutting insert mounted at the tip region of the head portion. The cutting insert includes: a body having a top surface, a leading face, an opposing trailing face, a first side and a second side; a T-land surface extending between the leading face and the top surface and extending between the leading face and the first side and second side; and a cutting edge formed at the intersection of the T-land surface and the top surface and at the intersection of the T-land surface and the first side and the second side.

In accordance with another aspect of the invention, a cutting insert for use in connection with a cutter bit includes: a body having a top surface, a leading face, an opposing trailing face, a first side and a second side; a T-land surface extending between the leading face and the top surface and extending between the leading face and the first side and second side; and a cutting edge formed at the intersection of the T-land surface and the top surface and at the intersection of the T-land surface and the first side and the second side.

These and other aspects of the present invention will be more fully understood following a review of this specification and drawings.

### BRIEF DESCRIPTION OF THE DRAWINGS

FIG. 1 is an exploded isometric view of a cutter bit, e.g. a stump grinding cutter bit, in accordance with an aspect of the invention.

FIG. 2 is an isometric view of a cutting insert for use with the cutter bit shown in FIG. 1, in accordance with an aspect of the invention.

FIG. 3 is a front view of the cutting insert shown in FIG. 2, in accordance with an aspect of the invention.

FIG. 4 is a top view of the cutting insert shown in FIGS. 2 and 3, in accordance with an aspect of the invention.

FIG. 4A is a sectional view taken along line 4A-4A of FIG. 4, in accordance with another aspect of the invention.

### DETAILED DESCRIPTION

The following description is for purposes of illustrating various aspects of the invention only and not for purposes of limiting the scope of the invention.

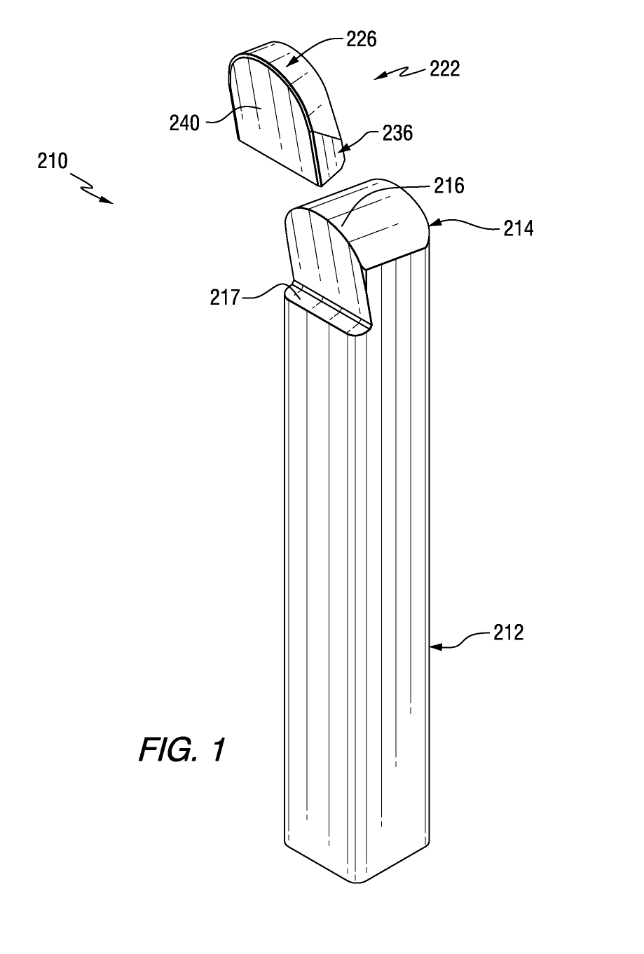

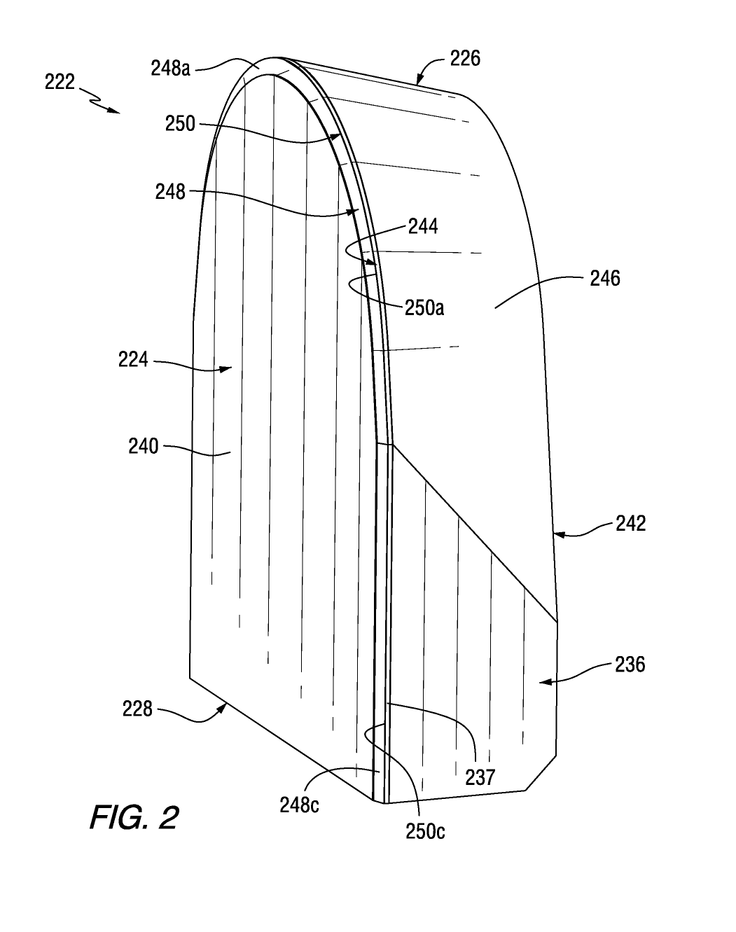

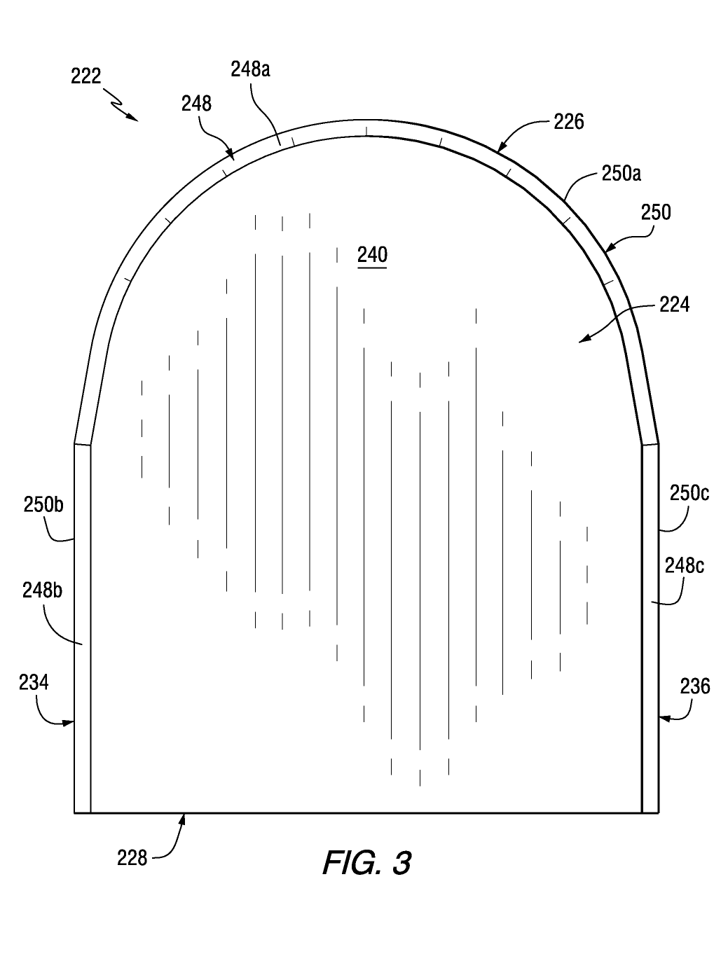

Referring to FIGS. 1-4A, there is illustrated a cutter bit in the form of, for example, a stump grinding cutter bit generally designated as 210, and a cutting insert generally designated as 222 for use therewith. It will be appreciated that the cutting insert 222 may be used with various types of stump grinding cutters such as, but not limited to, stump grinding bits disclosed in U.S. Pat. Nos. 4,998,574 or 8,020,591 both of which are hereby fully incorporated herein by reference.

The radial cutter bit 210 includes a shank portion 212 that is non-rotatable, i.e. the shank portion 212 does not rotate during operation once the radial cutter bit 210 is assembled by inserting the shank portion 212 of the cutting tool 210 into a tool holder base (not shown). In one aspect, the shank portion 212 has a generally non-circular cross-section, e.g. a generally square or rectangular cross-section.

The radial cutter bit 210 includes a forward working end that includes a head portion 214 integrally formed with the shank portion 212 and having a tip region 216 distal from the shank portion 212. The cutting insert 222 is mounted at the tip region 216 of the head portion 214. The cutting insert 222 is typically mounted or affixed to or on a shelf 217 defined at the tip region 216 of the head portion 214 by, for example, attaching mechanically or otherwise, via brazing, gluing, or press fitting using conventional compositions and techniques known to those skilled in the art.

The cutting insert 222 is made from, for example, a cemented tungsten carbide that is a mixture of cobalt and tungsten carbide. Other super hard, wear resistant materials such as polycrystalline diamond, ceramics, or cermet may be used as a supplement and/or substitute. For example chromium carbide-coated metals and other cermets where titanium carbide or vanadium carbide is added to tungsten carbide may be candidates for inserts materials in accordance to aspects of the invention. Alternate ceramics for such applications include aluminum-based, silicon based, zirconium-based and glass varieties. Still other insert materials alternatives include cubic refractory, transition metal carbides or any other known or subsequently developed material(s) harder than the base material. Also coatings of the inserts such as PVD or CVD coatings can be used.

In one aspect, the cutting insert 222 is made, for example, with a powder metallurgy process using a press comprising of a die and top and bottom ram/punch to press the complete shape. Parts can be pressed to finished shape or modified with a wet/dry blast, or diamond ground other material shaping processes such as but not limited to EDM (electrical discharge machining), EDG (electrical discharge grinding), green machining, laser ablation into final shapes. Advantageously, the invention provides for moving the critical cutting edge of the insert from the intersection of the die case and ram during manufacturing. In accordance with an aspect of the invention, the critical cutting edge is now formed entirely in the ram/punch. This eliminates the flash from forming on the cutting edge. Flash is undesirable because, for example, it is a stress concentrator. It will be appreciated that these and other aspects of the invention as set forth herein contribute to the desired edge, i.e. cutting edge, preparation for the cutting insert.

Cutting insert 222 has a cutting insert body, generally designated as 224, that has a top surface 226, a bottom surface 228, a first side 234 and a second side 236. The cutting insert body 224 also includes a leading face 240 and an opposite rearward or trailing face 242. In one aspect, the leading face 240 is a planar surface.

The top surface 226 of the cutting insert 222 includes a top relief surface 244. The top surface 226 of the cutting insert 222 also may include a top secondary relief surface 246 adjacent to the top relief surface 244, but it will be appreciated that one or more relief surfaces may be provided in accordance with the invention. In addition, the first side 234 includes a first side relief surface 235 and the second side 236 includes a second side relief surface 237.

The cutting insert 222 includes edge preparation such as a T-land surface, generally designated as 248, extending generally between at least a portion of the leading face 240 and top surface 226 and extending generally between at least a portion of the leading face 240 and the first side 234 and the second side 236. In one aspect, the T-land surface 248 includes a central T-land surface 248a extending between the leading face 240 and the top relief surface 244 of the top surface 226, a first side T-land surface 248b extending between the leading face 240 and the first side relief surface 235 of the first side 234 and a second side T-land surface 248c extending between the leading face 240 and the second side relief surface 237 of the second side 236. In one aspect, the central T-land surface 248a, the first side T-land surface 248b and the second side T-land surface 248c are contiguous with each other to provide for a continuous T-land surface 248. In one aspect, the central T-land surface 248a, the first side T-land surface 248b and the second side T-land surface 248c are contiguous with the leading face 240. In another aspect, the central T-land surface 248a is contiguous with the top relief surface 244, the first side T-land surface 248b is contiguous with the first side relief surface 235 and the second side T-land surface 248c is contiguous with the second side relief surface 237. In another aspect, the T-land 248 extends continuously from the bottom 228 adjacent the first side 234 to the bottom 228 adjacent the second side 236. It will be appreciated that the T-land surface 248 may be a planar surface or other than a planar surface, such as, for example it may include a rounded or curved, i.e. non-planar, T-land surface.

The cutting insert 222 further includes a cutting edge 250 formed at the intersection of the T-land surface 248 and the top surface 226 and at the intersection of the T-land surface 248 and the first side 234 and the second side 236. In one aspect, the cutting edge 250 includes a central cutting edge 250a formed at the intersection of the central T-land surface 248a and the top relief surface 244 of the top surface 226, a first side cutting edge 250b formed at the intersection of the first side T-land surface 248b and the first side relief surface 235 of the first side 234 and a second side cutting edge 250c formed at the intersection of the second side T-land surface 248c and the second side relief surface 237 of the second side 236. In another aspect, the central cutting edge 250a, the first side cutting edge 250b and the second side cutting edge 250c are contiguous with each other to provide for a continuous cutting edge 250 that extends continuously from the bottom 228 adjacent the first side 234 to the bottom 228 adjacent the second side 236. In one aspect, the cutting edge(s) 250 may be rounded.

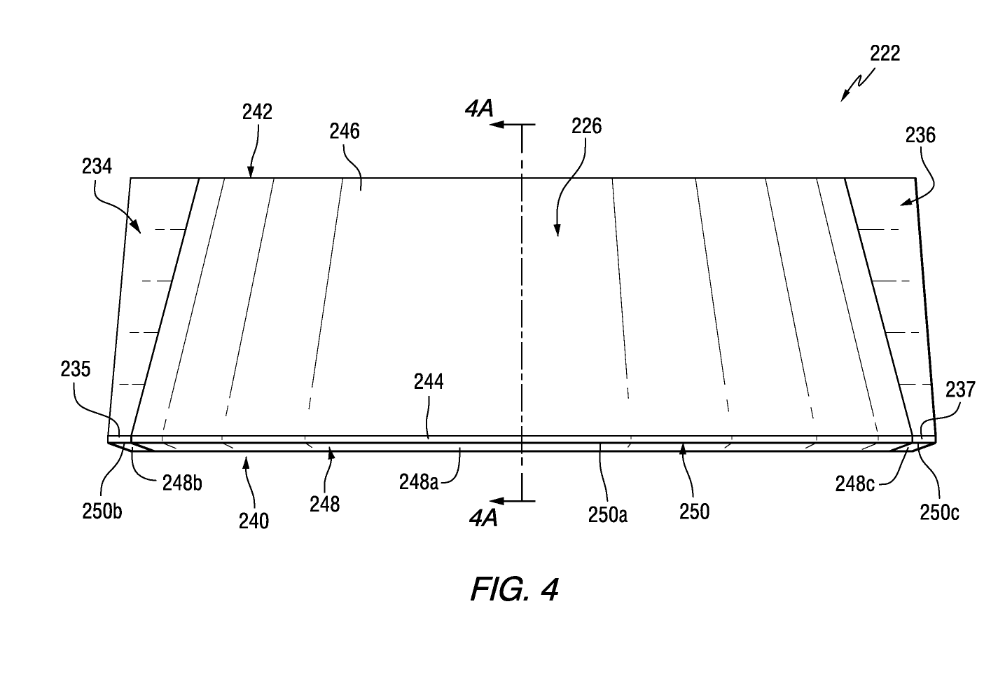

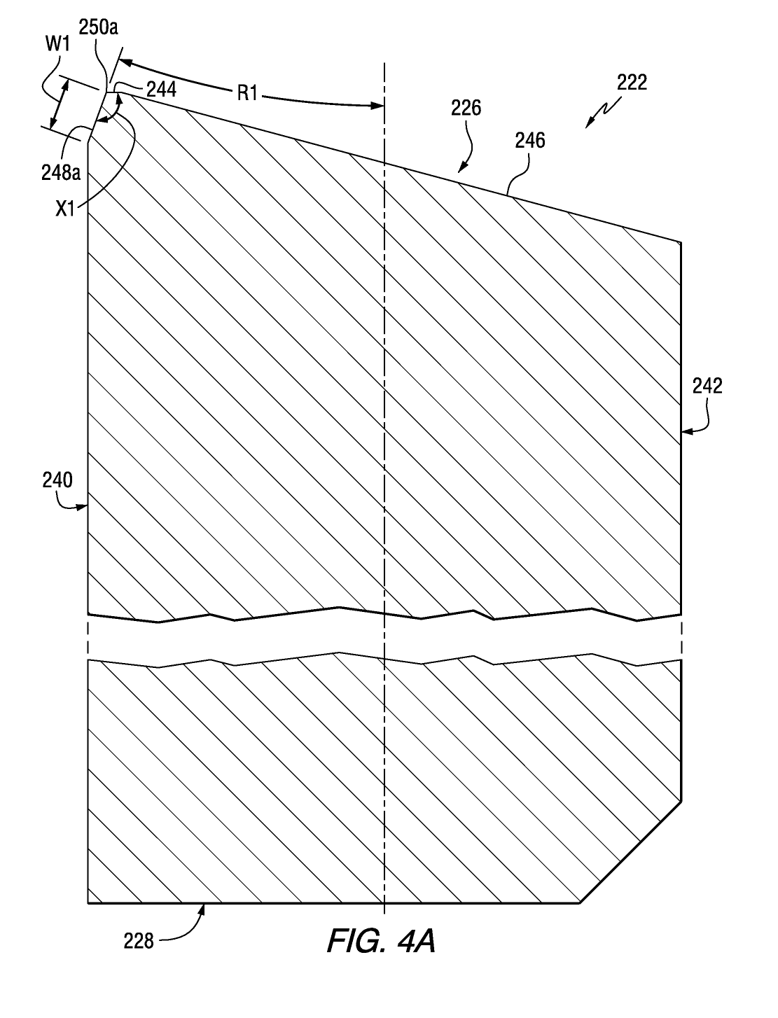

The configuration of having the central cutting edge 250a formed at the intersection of the central T-land surface 248a and the top relief surface 244 provides for the cutting edge 250a to have a negative axial rake angle R1 (see, for example, FIG. 4A). In one aspect, the negative axial rake angle R1 is in the range of about 10 degrees to about 60 degrees. In one specific example, the rake angle R1 shown in FIG. 4A is about negative 20 degrees. In another aspect, the first side cutting edge 250b and the second side cutting edge 250c also have a negative axial rake angle that may be, for example, the same as or similar to R1.

The central T-land surface 248a is positioned relative to the top relief surface 244 at an angle X1 (see, for example, FIG. 4A). The angle X1 may be referred to as a relief angle relative to or in relation to cutting edge 250a. In one aspect, the T-land surface 248a is positioned relative to the relief surface 244 at an angle X1 that is greater than 90 degrees. In one specific example, the angle X1 shown in FIG. 4A is about 110 degrees. In another aspect, the first side cutting edge 250b and the second side cutting edge 250c also have a relief angle that may be, for example, the same as or similar to X1.

In another aspect, the central T-land surface 248a may have a width W1 (see, for example, FIG. 4A) in the range of about 0.002 inches to about 0.090 inches. In one specific example, the width W1 is about 0.015 inches. In another aspect, the first side cutting edge 250b and the second side cutting edge 250c also have a width that may be, for example, the same as or similar to W1.

It will be appreciated that the configuration of the T-land(s) 248, cutting edge(s) 250, negative axial rake angle(s) R1 and/or the relief angle(s) X1 individually and/or in combination advantageously avoid a sharp transition for the cutting edge(s) 250 so as to reduce or minimize the possibility of the cutting edge 250(s) breaking or chipping during operation of the cutter bit 210. In addition, the T-land(s) 248 is configured so as to redirect the cutting forces along the cutting edge(s) 250 to reduce the shear stress along the cutting edge(s) 250.

Whereas particular aspects of this invention have been described above for purposes of illustration, it will be evident to those skilled in the art that numerous variations of the details of the present invention may be made without departing from the invention as defined in the appended claims.

What is claimed is:

1. A stump grinding cutter bit, comprising:
a non-rotatable shank portion;
a head portion integrally formed with the non-rotatable shank portion and including a tip region distal from the non-rotatable shank portion; and
a cutting insert mounted at the tip region of the head portion, wherein the cutting insert comprises:
a body having a top surface, a leading face, an opposing trailing face, a first side and a second side;
a T-land surface extending between the leading face and the top surface and extending between the leading face and the first side and second side; and
a cutting edge formed at the intersection of the T-land surface and the top surface and at the intersection of the T-land surface and the first side and the second side.

2. The stump grinding cutter bit of claim 1, wherein the cutting edge has a negative axial rake angle.

3. The stump grinding cutter bit of claim 1, wherein the T-land surface includes a central T-land surface extending between the leading face and a relief surface of the top surface, the cutting edge includes a central cutting edge formed at the intersection of the central T-land surface and the relief surface of the top surface, and the central cutting edge has a negative axial rake angle.

4. The stump grinding cutter bit of claim 3, wherein the T-land surface includes a first side T-land surface extending between the leading face and a first side relief surface of the first side, the cutting edge includes a first side cutting edge formed at the intersection of the first side T-land surface and the first side relief surface of the first side, and the first side cutting edge has a negative axial rake angle.

5. The stump grinding cutter bit of claim 4, wherein the T-land surface includes a second side T-land surface extending between the leading face and a second side relief surface of the second side, the cutting edge includes a second side cutting edge formed at the intersection of the second side T-land surface and the second side relief surface of the second side, and the second side cutting edge has a negative axial rake angle.

6. The stump grinding cutter bit of claim 5, wherein the central T-land surface, the first side T-land surface and the second side T-land surface are continuous.

7. The stump grinding cutter bit of claim 5, wherein the central cutting edge, the first side cutting edge and the second side cutting edge are continuous.

8. A cutting insert for use in connection with a cutter bit, the cutting insert comprising:
a body having a top surface, a leading face, an opposing trailing face, a first side and a second side;
a T-land surface extending between the leading face and the top surface and extending between the leading face and the first side and second side; and
a cutting edge formed at the intersection of the T-land surface and the top surface and at the intersection of the T-land surface and the first side and the second side.

9. The cutting insert of claim 8, wherein the cutting edge has a negative axial rake angle.

10. The cutting insert of claim 8, wherein the T-land surface includes a central T-land surface extending between the leading face and a relief surface of the top surface, the cutting edge includes a central cutting edge formed at the intersection of the central T-land surface and the relief surface of the top surface, and the central cutting edge has a negative axial rake angle.

11. The cutting insert of claim 10, wherein the T-land surface includes a first side T-land surface extending between the leading face and a first side relief surface of the first side, the cutting edge includes a first side cutting edge formed at the intersection of the first side T-land surface and the first side relief surface of the first side, and the first side cutting edge has a negative axial rake angle.

12. The cutting insert of claim 11, wherein the T-land surface includes a second side T-land surface extending between the leading face and a second side relief surface of the second side, the cutting edge includes a second side cutting edge formed at the intersection of the second side T-land surface and the second side relief surface of the second side, and the second side cutting edge has a negative axial rake angle.

13. The cutting insert of claim 12, wherein the central T-land surface, the first side T-land surface and the second side T-land surface are continuous.

14. The cutting insert of claim 12, wherein the central cutting edge, the first side cutting edge and the second side cutting edge are continuous.

15. The cutting insert of claim 12, wherein the leading face is a planar surface.
